(19) United States
(12) Patent Application Publication
(10) Pub. No.: US 2013/0255113 A1
(43) Pub. Date: Oct. 3, 2013

(54) Snow Plow Rack and System

(71) Applicant: Mark Carroll, Waterbury, CT (US)

(72) Inventor: Mark Carroll, Waterbury, CT (US)

(21) Appl. No.: 13/430,780

(22) Filed: Mar. 27, 2012

(51) Int. Cl. B60R 9/06; B60R 9/00; E01H 5/06

(52) U.S. Cl. 37/241; 224/401

(57) ABSTRACT

The disclosed invention relates to a rack and a rack system removeably attachable to a snow plow, the rack comprising: a base; a first vertical member extending generally orthogonally from the base; a second vertical member extending generally orthogonally from the base; a first and second attachment members both with a distal end and a proximal end, with the proximal ends attached to from generally the top of the first and second vertical member respectively, and the first and second attachment members: extending orthogonally from generally the top of the first and second vertical members respectively and configured to extend towards a snow plow, and the distal ends configured to each attach to generally the top of a snow plow; where the rack is configured to attach to the scoop end of a snow plow and to carry items.

### TECHNICAL FIELD

This invention relates to a rack that is removeably attachable to a snow plow, and more specifically to a rack that is configured to hold equipment such as a snow blower, a spreader, and bags of material.

### BACKGROUND

In many parts of the world snow plows and snow blowers are necessary to deal with snow and ice on the roads, driveways, and sidewalks, among other areas. Often, when a snow plow is attached to a vehicle, such as, but not limited to, a pick-up truck, the bed of the pick-up truck is often used to carry items which may generally fill up the bed. Items such as sanders with road salt and sand, or other materials to make roads, sidewalks, driveways safer for travel. When a pick-up truck has the bed filled with such material, there usually is not room for a snow blower in the bed of the truck. Thus, if a user wants both a snow plow and snow blower available, a second vehicle, requiring a second driver is often required to transport the snow blower.

In addition, even if there is room in the bed of a truck, moving a heavy snow blower from and to the bed of a pick-up truck is an arduous task, that can lead to injury and expensive workman's compensation claims.

Thus, there is a need for an apparatus that can overcome the above and other disadvantages.

### SUMMARY

The disclosed invention relates to a rack removeably attachable to a snow plow, the rack comprising: a base; a first vertical member extending generally orthogonally from the base; a second vertical member extending generally orthogonally from the base; a first attachment member with a distal end and a proximal end, with the proximal end attached to from generally the top of the first vertical member, and the first attachment member extending orthogonally from generally the top of the first vertical member and configured to extend towards a snow plow, and the distal end configured to attach to generally the top of a snow plow; a second attachment member with a distal end and a proximal end, with the proximal end attached to generally the top of the second vertical member, and the second attachment member extending orthogonally from generally the top of the second vertical member and configured to extend towards a snow plow, and the distal end configured to attach to generally the top of a snow plow; where the rack is configured to attach to the scoop end of a snow plow and to carry items.

The invention also relates to a snow plow rack system comprising: a snow plow; a first pin with a retaining clip hole extending generally vertically from generally the top of the snow plow; a second pin with a retaining clip hole extending generally vertically from generally the top of the snow plow; a rack configured to removeably attach to the snow plow, the rack comprising: a base; a first vertical member extending generally orthogonally from the base; a second vertical member extending generally orthogonally from the base; a first attachment member with a distal end and a proximal end, with the proximal end attached to from generally the top of the first vertical member, and the first attachment member extending orthogonally from generally the top of the first vertical member and configured to extend towards a snow plow, and the distal end configured to attach to generally the top of a snow plow; a second attachment member with a distal end and a proximal end, with the proximal end attached to generally the top of the second vertical member, and the second attachment member extending orthogonally from generally the top of the second vertical member and configured to extend towards a snow plow, and the distal end configured to attach to generally the top of a snow plow; a first support member attached to the base and to the first vertical member; a second support member attached to the base and to the second vertical member; where the base comprises: a first angle iron attached to a second angle iron, a third angle iron attached to the second angle iron; a fourth angle iron attached to the third angle iron and the first angle iron; where the first, second, third and fourth angle irons are arranged generally in a rectangular shape; a metal grate located near a plow end of the base, and located generally along the entire length of the base and generally about ⅓ of the width of the base; a first cross member attached to the base and located generally across an entire length L of the base, and generally divides an open space in the base in half; a first hole located generally at the distal end of the first attachment member, and configured to slide over the first pin; a second hole located generally at the distal end of the second attachment member, and configured to slide over the second pin; a first retaining clip configured to slide into the retaining clip hole in the first pin and further configured to removeably prevent the first attachment member from sliding off the first pin; a second retaining clip configured to slide into the retaining clip hole in the second pin and further configured to removeably prevent the second attachment member from sliding off the second pin. at least one ratchet strap configured to hold at least one item in the rack; at least one ratchet strap to configured to further secure the rack to a snow plow; and where the rack is configured to attach to the scoop end of a snow plow and to carry items.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a perspective view of the rack adjacent to a snow plow;

FIG. 2 is a rear perspective view of the rack;

FIG. 3 is front perspective view of the rack with the rack slid onto the pins of the plow;

FIG. 4 is a perspective view of the rack with a snow blower located on the rack;

FIG. 5 shows one embodiment of parts and a parts list for the system;

FIG. 6 shows one embodiment of a method for assembling the rack;

FIG. 7 shows one embodiment of a method for installing the rack on a snow plow; and

FIG. 8 shows another embodiment of the rack configured to hold other items.

### DETAILED DESCRIPTION

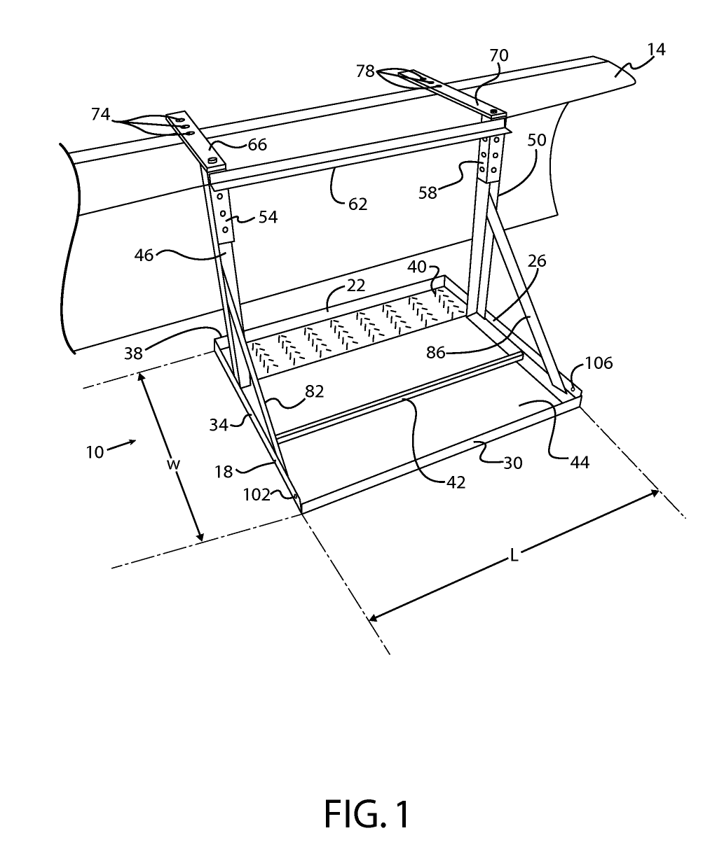

FIG. 1 is a perspective view from the non-plow side of the rack 10 which shows the rack 10 located on a snow plow 14. In this view, the rack 10 is not yet attached to the plow 14. The rack comprises a base 18. In one embodiment, the base 18 may comprise four angle irons 22, 26, 30, 34 arranged generally in a rectangular or square shape. Near the plow end 38 of the base, a metal grate 40 or other solid piece of material is located generally along the entire length L of the base and generally about ⅓ of the width W of the base. A first cross member 42 is located generally across the entire length L of the base, and generally divides the open space 44 in half. However, in different embodiments the cross member 42 may be located closer to the angle iron 30 or closer to the grate 40. Attached to the base 18 is a first vertical member 46, and a second vertical member 50. The vertical members 46, 50 may be located generally adjacent to or near the non-plow side of the grate 40. However, in other embodiments, the vertical members 46, 50 may be located in other suitable locations on the base 18. Attached generally to the top of the first vertical member 46 is a first box unit with holes 54. Attached generally to the top of the second vertical member 50 is a second box unit with holes 58. In another embodiment, the box units with holes 54, 58 may be omitted, and the vertical members 46, 50 may instead have attachment holes generally located near the top of each member. Attached generally near the top of both vertical members 46, 50 is a second cross member 62. Extending horizontally and towards the plow from generally the top of the first vertical member 46 is a first attachment member 66. Likewise, extending horizontally and towards the plow from generally the top of the second vertical member 50 is a second attachment member 70. On the plow side (distal end) of the first attachment member 66 is at least one attachment hole 74. Three attachment holes 74 are shown, but there may be more or fewer holes 74. On the plow side (distal end) of the second attachment member 70 is at least one attachment hole 78. Three attachment holes 78 are shown, but there may be more or fewer holes 78. The attachment members 66, 70 are shown extending over the back side of the plow 14 as shown. This is because the rack 10 may fit on various sized plows. Optional support members 82, 86 may be attached to the first vertical member 46 and base 18, and the second vertical member 50 and base 18, respectively. The base 18 will have a first strap hole 102, and a second strap hole 106. In one embodiment the first strap hole 102 may be located in the angle iron 34, and the second strap hole is located in the angle iron 26.

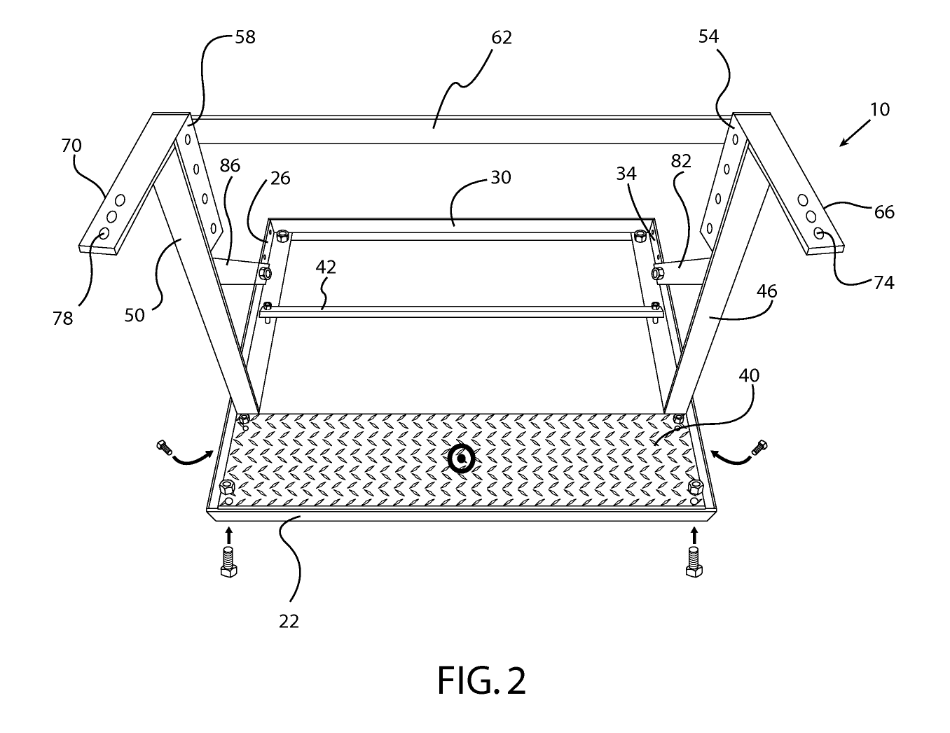

FIG. 2 is a perspective view of the rack 10 from the plow side of the rack.

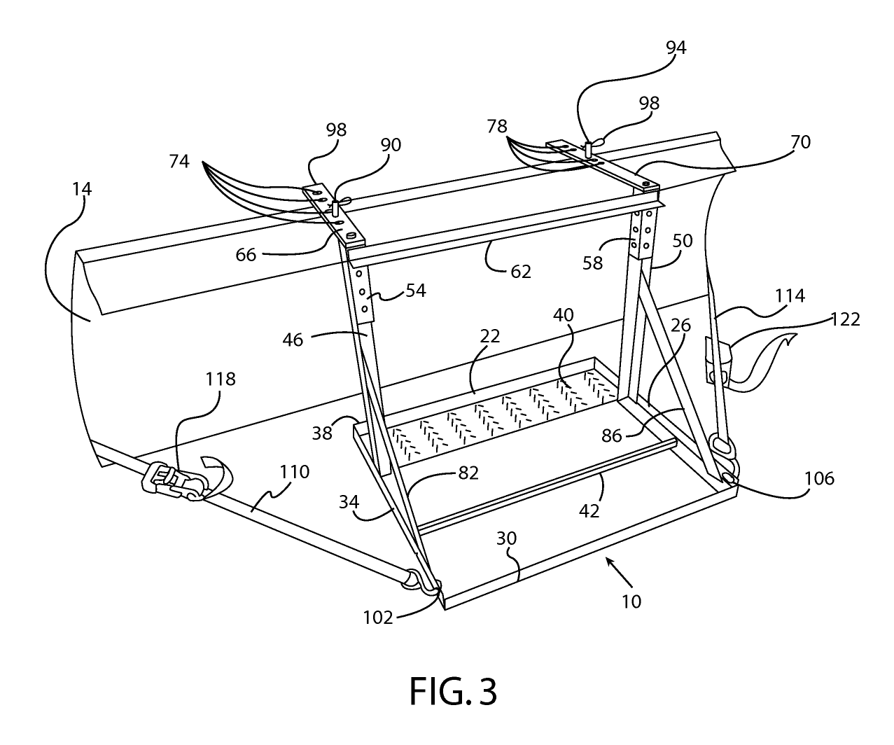

FIG. 3 is a perspective view of the rack 10 attached to a snow plow 14. In this embodiment, the top of the snow plow had two holes drilled into it. A first pin 90, and second pin 94 is attached to each of the holes, such that the pins 90, 94 extend from the top of the plow 14. The first and second attachment members 66, 70 are lowered onto the two pins 90, 94 via the attachment holes 74, 78. A retaining clip 98 may be configured to attach to each of the pins 90, 94 to prevent the first and second attachment members 66, 70 and the rack 10 from sliding off the pins 90, 94. Also, a hole is drilled into generally each of the two lower back corners of the plow 14, the holes are not visible in this view. In order to provide additional support of the rack 10 on the plow 14, a first strap 110 is removeably attached to the first strap hole 102 and to one of the holes on the lower back corner of the plow 14. In addition, a second ratchet strap 114 is removeably attached to the second strap hole 106 and to the other hole on the lower back corner of the plow 14. The ratchet straps 110, 114 may attach to the rack 10 and plow 14 via any suitable attachment means, including but not limited to “S” hooks. The ratchet straps 110, 114, can be tightened using the ratchets 118, 122 located on the straps 110, 114.

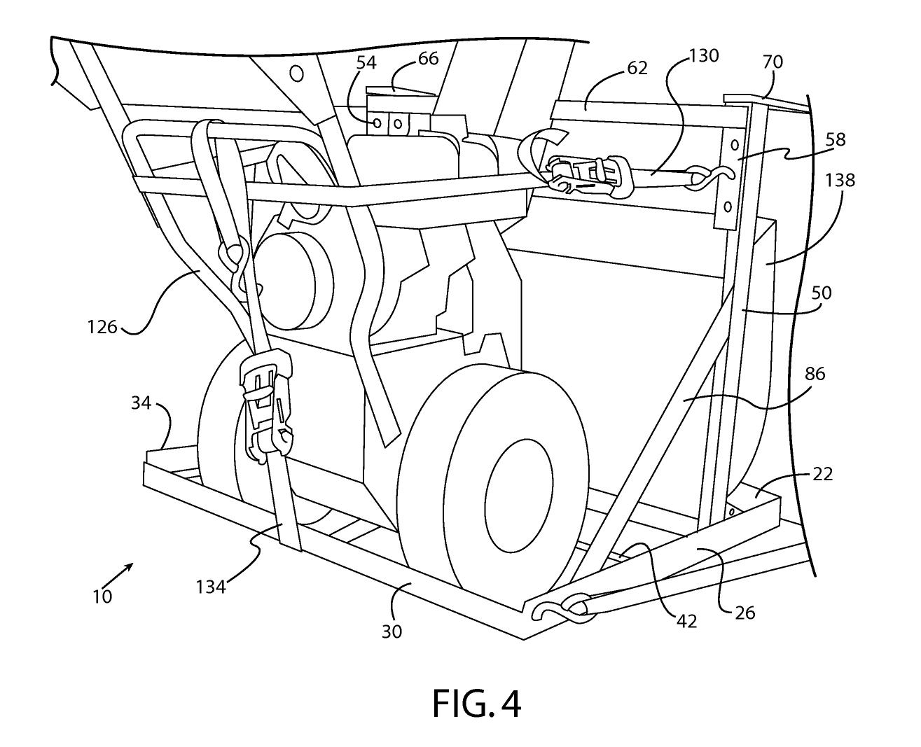

FIG. 4 shows a snow blower 126 installed on the rack 10. A third ratchet strap 130 is attached to the first and second box units 54, 58 and across the top of the snow blower 126. A fourth ratchet strap 134 is also attached to the top of the blower and down to the first cross member 42, or elsewhere on the rack 10. Once the third and fourth ratchet straps 130, 134 are tightened, the blower 126 is securely fasted to the rack 10. The rack 10 may be configured so that the front end of the snow blower 126 where the snow scoop 138 and snow blades (not visible in this view) may be adjacent to the scoop of the snow plow 14.

When the rack is attached to the snow plow, and then the snow blower is attached to the rack, the snow plow can be raised or lowered. When the snow plow is raised, the rack and snow blower are raised along with the plow, and clear the ground, and the vehicle with the snow plow can travel about the roads with the plow and rack and snow blower not coming in contact with the road.

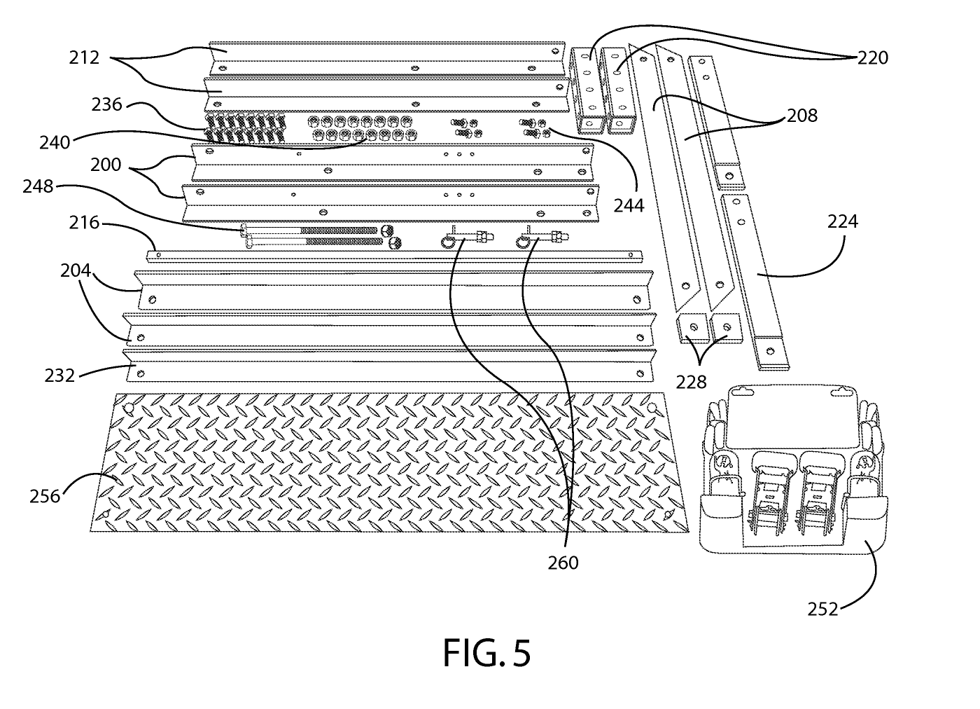

FIG. 5 shows one embodiment of the parts and parts list for assembling the rack 10. It should be noted that the dimensions listed for the parts list are merely examples for one embodiment of the parts comprising the rack, and that the rack 10 may be sized to be larger, or smaller. In addition, the individual components that may comprise the rack 10 may also be sized to be larger, smaller, longer, shorter, etc.

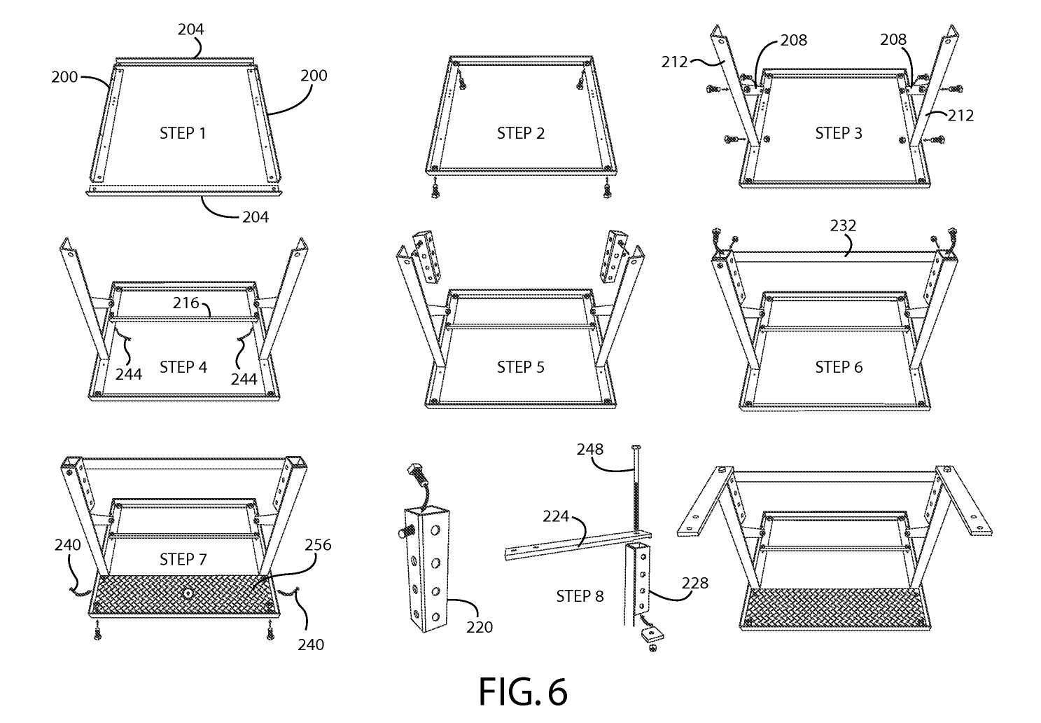

FIG. 6 shows one embodiment of a method for assembling the rack 10. It should be noted that the dimensions listed are merely examples for one embodiment of the method, and the dimensions may be sized to be larger, or smaller.

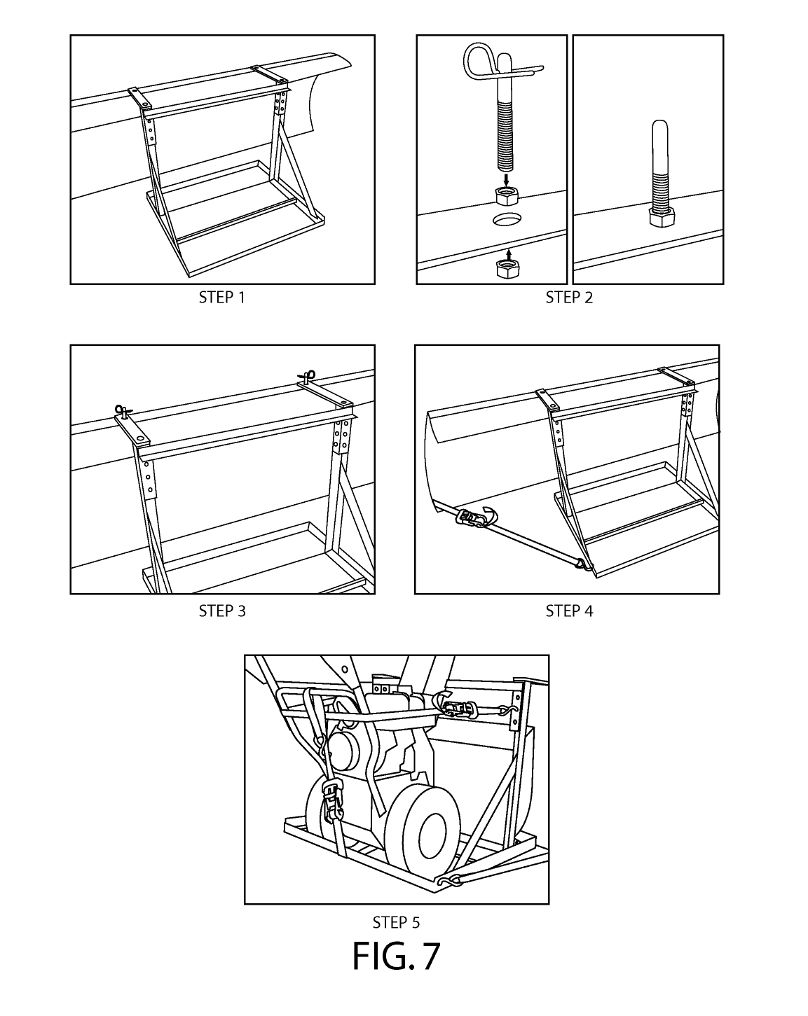

FIG. 7 shows one embodiment of a method for installing the rack on a snow plow. It should be noted that the dimensions listed are merely examples for one embodiment of the method, and the dimensions may be sized to be larger, or smaller.

Although the disclosed rack has been described with use for attaching a snow blower to a snow plow, other devices, tools and equipment may be attached to the rack, and then attached to the plow. Such articles include, but are not limited to: shovels, ice choppers, garbage cans.

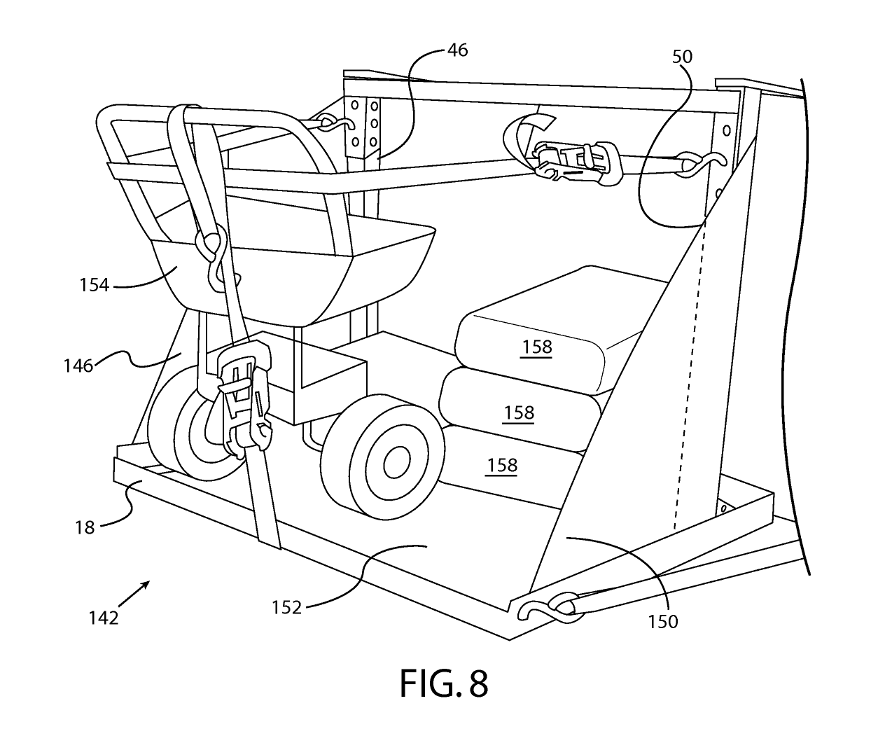

FIG. 8 shows another embodiment of the rack 142. In this embodiment, the left side of the rack may have a left side wall 146 that extends from the base 18 to at least the first vertical member 46. In addition, the right side of the rack 142 may have a right side wall 150 that extends from the base 18 to at least the second vertical member 50. The base 18 of the rack 142 may have a floor 152 that generally covers the entire base 18 and the open space 44 (no longer visible due to the floor 152) in the base 18. In this embodiment, the rack 142 may be used to transport other items including, but not limited to a spreader 154, and multiple bags of material 158, such as but not limited to sand and salt.

The disclosed device has many advantages. The rack allows a vehicle equipped with a snow plow to carry a snow blower (as well as other items, including but not limited to a spreader, bags of material), as well as having the bed generally filled with a sander and sand and salt. In addition, the use of the rack, will allow a user to only require one vehicle, as opposed to having a second vehicle just to transport the snow blower. Also, because snow plows may be hydraulically raised and lowered, the plow may be lowered, to allow easy removal and installation of the snow blower to the rack while it is located on the ground. Now, a user will not have to lift the snow blower from the ground into the back of a vehicle, or lift a snow blower from the back of a vehicle and lower it to the ground, thus preventing injuries to the person moving the snow blower. The above disclosed invention may save on workman's compensation claims. In addition, the rack can be installed or removed in about 90 seconds.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A rack removeably attachable to a snow plow, the rack comprising:
a base;
a first vertical member extending generally orthogonally from the base;
a second vertical member extending generally orthogonally from the base;
a first attachment member with a distal end and a proximal end, with the proximal end attached to from generally the top of the first vertical member, and the first attachment member extending orthogonally from generally the top of the first vertical member and configured to extend towards a snow plow, and the distal end configured to attach to generally the top of a snow plow;
a second attachment member with a distal end and a proximal end, with the proximal end attached to generally the top of the second vertical member, and the second attachment member extending orthogonally from generally the top of the second vertical member and configured to extend towards a snow plow, and the distal end configured to attach to generally the top of a snow plow;
wherein the rack is configured to attach to the scoop end of a snow plow and to carry items.

2. The rack of claim 1, wherein the items are selected from the group consisting of a snow plow, a spreader with several bags of material, a spreader, several bags of material.

3. The rack of claim 1, further comprising:
a first support member attached to the base and to the first vertical member;
a second support member attached to the base and to the second vertical member;
wherein the base comprises:
a first angle iron attached to a second angle iron,
a third angle iron attached to the second angle iron;
a fourth angle iron attached to the third angle iron and the first angle iron;
where the first, second, third and fourth angle irons are arranged generally in a rectangular shape;
a metal grate located near a plow end of the base, and located generally along the entire length of the base and generally about ⅓ of the width of the base;
a first cross member attached to the base and located generally across an entire length L of the base, and generally divides an open space in the base in half;
a first hole located generally at the distal end of the first attachment member, and configured to slide over a first pin extending generally vertically from a top of a snow plow;
a second hole located generally at the distal end of the second attachment member, and configured to slide over a second pin extending generally vertically from the top of a snow plow.

4. The rack of claim 3, further comprising:
a first retaining clip configured to slide into a hole located on the first pin and further configured to removeably prevent the first attachment member from sliding off the first pin;
a second retaining clip configured to slide into a hole located on the second pin and further configured to removeably prevent the second attachment member from sliding off the second pin.

5. The rack of claim 1 further comprising:
at least one ratchet strap configured to hold at least one item in the rack;
at least one ratchet strap configured to further secure the rack to a snow plow.

6. A snow plow rack system comprising:
a snow plow;
a first pin with a retaining clip hole extending generally vertically from generally the top of the snow plow;
a second pin with a retaining clip hole extending generally vertically from generally the top of the snow plow;
a rack configured to removeably attach to the snow plow, the rack comprising:
a base;
a first vertical member extending generally orthogonally from the base;
a second vertical member extending generally orthogonally from the base;
a first attachment member with a distal end and a proximal end, with the proximal end attached to from generally the top of the first vertical member, and the first attachment member extending orthogonally from generally the top of the first vertical member and configured to extend towards a snow plow, and the distal end configured to attach to generally the top of a snow plow;
a second attachment member with a distal end and a proximal end, with the proximal end attached to generally the top of the second vertical member, and the second attachment member extending orthogonally from generally the top of the second vertical member and configured to extend towards a snow plow, and the distal end configured to attach to generally the top of a snow plow;
a first support member attached to the base and to the first vertical member;
a second support member attached to the base and to the second vertical member;
wherein the base comprises:
a first angle iron attached to a second angle iron,
a third angle iron attached to the second angle iron;
a fourth angle iron attached to the third angle iron and the first angle iron;
where the first, second, third and fourth angle irons are arranged generally in a rectangular shape;
a metal grate located near a plow end of the base, and located generally along the entire length of the base and generally about ⅓ of the width of the base;
a first cross member attached to the base and located generally across an entire length L of the base, and generally divides an open space in the base in half;
a first hole located generally at the distal end of the first attachment member, and configured to slide over the first pin;
a second hole located generally at the distal end of the second attachment member, and configured to slide over the second pin;
a first retaining clip configured to slide into the retaining clip hole in the first pin and further configured to removeably prevent the first attachment member from sliding off the first pin;
a second retaining clip configured to slide into the retaining clip hole in the second pin and further configured to removeably prevent the second attachment member from sliding off the second pin.
at least one ratchet strap configured to hold at least one item in the rack;
at least one ratchet strap to configured to further secure the rack to a snow plow; and
wherein the rack is configured to attach to the scoop end of a snow plow and to carry items.

7. The system of claim 6, wherein the items are selected from the group consisting of a snow plow, a spreader with several bags of material, a spreader, several bags of material.
